(19) United States
(12) Patent Application Publication
(10) Pub. No.: US 2015/0039463 A1
(43) Pub. Date: Feb. 5, 2015

(54) SYSTEM FOR MANAGING SERVICE REQUESTS

(71) Applicant: Pier Paolo Stoppino, Milan (IT)

(72) Inventors: Pier Paolo Stoppino, Milan (IT); Alex Pagnoni, Pesaro (IT); Mariagrazia Gaini, Milan (IT)

(73) Assignee: Pier Paolo Stoppino, Milan (IT)

(21) Appl. No.: 13/957,654

(22) Filed: Aug. 2, 2013

(51) Int. Cl. G06Q 30/06

(52) U.S. Cl. CPC G06Q 30/0633
USPC 705/26.8

(57) ABSTRACT

The invention disclose a system for managing service requests, comprising:
at least a database (1) for storing data of service requestors (2) and service executors (3);
a web interface (4) for the service requestors (2), for manually entering service requests (5) in the database (1), each service request (5) including at least a unique identifier, a date and a place of service request and payment information for the service execution;
a web interface (6) for the service executors (3), for searching service requests (5) in the database (1) and for selecting one or more service requests (5) to be executed,
   wherein the interface (4) of the service requestors (2) includes means for identifying the executors (3) who have selected the service requests (5), means for accepting the service execution from a service executor (3) and means for closing the service requests (5) after execution, said means for closing the service request comprising a payment to the service executor (3) for the executed service.

The invention further discloses a method for managing service requests.

### FIELD OF APPLICATION

The present invention relates to a system and method for managing service requests with a computer implemented system. More particularly, the invention relates to a system and method of the typed cited above to support service requestors to make service requests and service executors to find service requests.

### PRIOR ART

In the field of system for managing service requests are known computer implemented system, for example monster.com, which connects people who are searching a job and employers offering a job. Such a system provide means for searching by geographical area, by contract type, by professional features or experience, to publish curriculum vitae and some other tools to create contacts between who is searching and who is offering. These systems are limited being utilized to create continuous medium/long term (more than one day) work relationships and in addition they are not used especially once a people has been employed,

Other systems, for example 5dollarsgigs.com, favor making contact between a requestor, requesting a service to be executed on-line, and the executors which makes the service on-line for few dollars, for example, publishing or writing an article in a blog, or removing remotely a PC from a virus or malware. However, such system include only services to be executed through a computer system and does not include any information about when, where or how the service should be completed in person.

There are other systems, for instance twago.com or freelancer.com for describing a project to be executed, to receive offers, and selecting suppliers. However, also in this case the project is implemented via PC, and the related request does not include any information on a precise timing (including hour, frequency and occurrence) and place for service to be executed.

So the known systems are limited to create contacts between professional expertise and companies, especially in the field of information technologies, and are not adapted to serve a wide part of people not having a professional experience in a specific technological field who however need to work because, for example, unemployed. In addition, current service requests does not include any precise information on where, how and when, service should be executed. In this respect, an application known as “iamexec”, assigns a specific service request to a team which is hired from a company specialized in said specific service, and thus it is limited to assist and improve work of companies highly specialized.

At last, some systems for managing service requests fails to support a consistent organization of services in a daily, weekly or monthly agenda, do not support a complete workflow of the phases from the request, to an acceptance of the request, to its execution and payment, do not allow to mark service requests which are uncompressible or not well formulated, or to mark unreliable executors who did not satisfy a service request or unreliable requestor who failed to pay, thus leaving the requestor and the executors unsure on the reliability of the service provided, on one side, and on the payment expected, on the other side.

The problem at the base of the present invention is that of providing a method and a system for managing service request and to allow all people (not previously defined neither belonging to any pre-defined category),

### SUMMARY OF THE INVENTION

The idea of solution at the base of the present invention is that of providing a system for managing service requests, the system comprising:
at least a database for storing data of service requestors and service executors;
a web interface for the service requestors, for manually entering data of service requestors in the database and data of the service requests, each service request including at least a unique identifier, a date and a place of service request and payment information for the service execution;
a web interface for the service executors, for manually entering data of service executors in the database, for searching service requests and for selecting one or more service requests to be executed,
   wherein the interface of the service requestors includes means for identifying the executors who have selected the service requests, means for accepting the service execution from a service executor and means for closing the service requests after execution, said means for closing the service request comprising a payment to the service executor for the executed service.

Indicating date, hour, frequency (occurrence) and the place of service request allows managing the execution of physical services. For instance the requestor may be an elderly impeded to move and requesting to buy food at a supermarket or to mow the lawn as a service, and the service executor may be a young men who is interested in making such a service for an offered amount of money. Thus, differently from the prior art system, also short or one time engagement for a single physical service, to be executed in a physical place and at a certain time, are managed. Scheduling a plurality of service request to be executed in physical places not far one from the other let the service executor to program his day and to calculate the sum of money in advance.

In an aspect of the invention, the interface of the service requestor and/or the interface of the service executors includes means for entering a score to the service requestor and/or to the service executors, respectively, said score being stored with the data of service requestors and service executors in said database. Advantageously, a score system help the requestor of the executors to trust and to cut out from the system, for example marking as unreliable or removing from the database, who does not execute a service as required or who does not pay for the required service.

The interface of the service requestor further include means for entering in said database at least one of the information included in the group of a description of the service request, a ZIP code associated to said place, information associated to the service requestor, an hour for the service execution and/or an hour for the service completion, and said payment information include at least one of the information included in the group of an offered amount for the service execution, a mode of payment and a time of payment. Advantageously, the system helps the requestor to specify all the information necessary for the execution of the request; more particularly, a text, video or audio file may be enclosed to the request to explain how precisely to execute the service and to put the executor to be soon in condition to make the job.

The interface of the service requestor further includes means for entering in the database at least one of the information included in the group of a name and a surname of the service requestor, a VAT number, an address, a phone number, a username payment references, a fiscal code. This information supports the first contact with the executors searching a service and the following workflow, till completion of the service. According to an embodiment of the invention, not all the information is available at the first contact, for example the VAT number may be hidden as a sensible information.

The interface of the service executors further includes at least one of the information included in the group of a name and a surname of the service executors, a VAT number, an address, a phone number, a username payment reference, a fiscal code. Also this information supports the first contact with the requestor requesting a service and the following workflow, till completion of the service, and also in this case not all the information may be rendered available at the first contact, for example the VAT number of the executors may be hidden.

The interface of the service executors further includes an agenda wherein the services selected from an executors for execution and the services accepted by the requestors are displayed, preferably grouped, more preferably grouped by day of the month, wherein possible overlapping among said selected services and said accepted services are highlighted to prevent conflicts. Advantageously, the agenda supports the scheduling of services to help the executors organizing his day, week or month of services, taking also in consideration the physical place wherein they will be executed, and thus considering for example travelling time. In an embodiment of the invention, the system including means for preventing a selection of a service request in a day and hour including service requests already accepted by the or another requestor.

The agenda further includes means for calculating and displaying a sum of money for all the service requests executed or to be executed in a certain day of the week or of the month or a sum of money for all the service executed or to be executed in a certain month.

In one aspect of the invention, the system including a portable device, preferably an I-phone or I-pad or tablet or mobile phone or computer, for displaying and editing said interfaces and agenda. Preferably, the portable device include means for geo-localization, for instance a GPS, wherein said means for searching the service request cooperate with the geo-localization means to provide the service executors with service requests near an actual location of the service executor. Preferably, according to this aspect, the service requests associated with an hour in which the service executor is located at a place where in the service request is requested are displayed before.

In one aspect, the amount for the service execution is set by the service requestor in the service request. If not set by the service requestor when entering the service request, it is set by the service executor.

The interface of the service executor further comprises means for confirming execution of a service request to be executed and which has been already accepted by a service requestor and means for confirming payment receipt for the service execution after payment of the service requestor. According to this aspect, the workflow is completed only when the executors confirms the receipt of the payment. Moreover, after acceptance by the requestor, the executor may refuse the execution, for example due to a changed availability, thus interrupting the workflow.

The interface of the service requestor further include means for entering in said database at least one of the information included in the group of a number of executors requested to executed a service request and a number and or frequency of repetitions of the service request, and a mode of payment of said services in the repetition, the mode including one payment for each service of said repetition or a unique payment for all the services in the repetition. Advantageously, the system of the invention allow to manage physical services requiring more than one person or physical services to be executed in more sessions.

In case a preliminary expense is needed before execution, the system further include means for entering preliminary expenses to be covered by the service requestor with payment, before said service execution.

The system according to the present invention further provides a phone call or SMS or messaging (e-mail, chat, instant messaging, etc) as means for entering in said database data concerning the service request, the service requestor or the service executors.

The system is implemented with a single platform. More particularly, the interface of service executors and the interface of service requestor are included in said platform, as well as the database(s) for storing data of executors, data of requestors and request of services, or the means for managing such data. In another advantageous aspect of the system, the interface of the service executors and/or the interface of the service requestor further include means for entering in the database a proposal to change the service request. The proposal includes, preferably, a change in a time or day for the execution of the service or in an amount of the payment; of course, different information to change the request, i.e. proposals of different kind, may be entered, for instance in a text field.

In a further aspect of the invention, the services selected from an executor for execution and the services accepted by the requestors are displayed and ordered in the agenda by their status. The status, for instance, indicates that the request has been accepted by the requestor and/or by the executor, or that the service is running or has been completed; of course, several intermediate statuses may be supported.

The status may also be ‘available’, ‘waiting for confirmation’ or ‘bad’ request. Such statuses implement a workflow for the service execution. More particularly, a status is set by the requestor or by the executor; in this respect, any action taken by the requestor or the executor corresponds to a status change in the workflow of the service execution.

The problem above identified is also solved by a method for managing service requests, comprising:
storing in a database data of service requestors and service executors;
entering in the database data of service requestors,
entering in the database data of the service requests, including at least a unique identifier, a date and a place of service request and payment information for the service execution;
entering in the database data of service executors,
searching in the database service requests and selecting one or more service requests to be executed,
identifying the executors who have selected the service requests, accepting the service execution from a service executor and closing the service requests after execution, wherein closing the service comprises paying the service executor for the executed service.

### BRIEF DESCRIPTION OF THE DRAWINGS

FIG. 1 is a diagram schematically representing a system for managing service requests according to the present invention.

FIG. 2 is a diagram schematically representing a workflow managed according to the system of FIG. 1.

FIGS. 3-4 are diagrams schematically representing some specific steps of a workflow managed according to the system of FIG. 1.

FIG. 5 is a table corresponding to an agenda stored by a service executor through the system of FIG. 1.

FIG. 6 is a diagram schematically representing an interaction between a service requestor and a service executor, according to the system of FIG. 1.

FIG. 8-15 are block diagrams schematically representing specific controls and workflows implemented by the system of FIG. 1.

### DETAILED DESCRIPTION

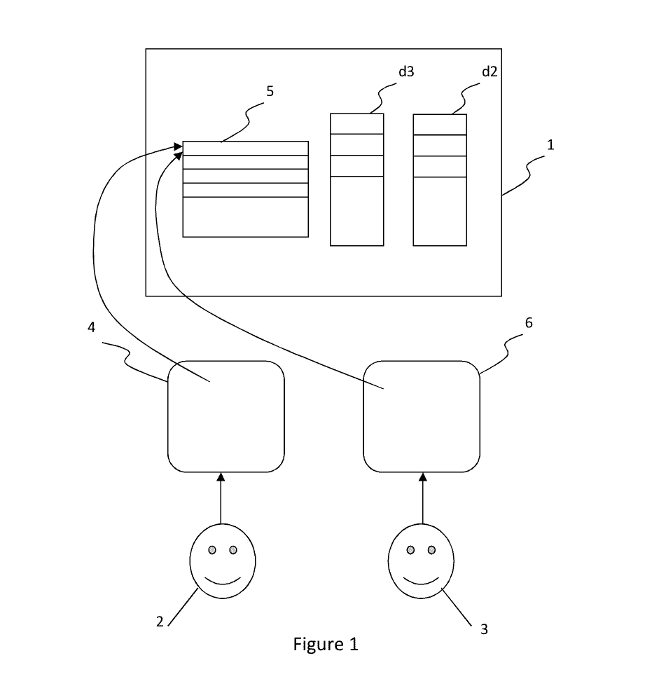

With reference to FIG. 1, a system for managing service requests is schematically represented and comprises at least a database 1 for storing data d2, d3 of service requestors 2 and service executors 3 of a service.

In the following description, a service executor 3 is a man or a woman not belonging to a particular category of workers, to a cooperative, to an association or to an employer; more particularly, the system does not require that the service executor 3 specify his or her technical background, competence, degree, etc. In other words, the system allows any people to candidate for an execution of a service request 2. Similarly, it is not requested that the service executor 3 is an employee or under a job contract of another entity, employer, cooperative or intermediate providing a service, and the system is open to any person interested to provide a service to gain money. Moreover, it is not requested that the service executor 3 are located or belong to a same or predetermined geographical area.

FIG. 1 schematically represents a web interface 4 for the service requestors 2, which is used for manually entering data d2 of service requestors 2 in the database 1 and data of the service requests 5. More particularly, each service request 5 includes at least a unique identifier, a date, a place of the service request and payment information for the service execution. Preferably, the service request 5 includes further information, comprising at least one in the group of an hour, a frequency and/or an occurrence of a repetition of the service and a number of service executor required to make the service.

In this respect, according to the invention, the system stores a plurality of information to define really precisely the service request 5. Such precision is important to assure that the service requestor 2 may specify all the details of the request 5 and thus to contribute in the real satisfaction of the service requestor 2 for the service execution. At the same time, the precision in the definition of the request 5 assure that the service executor 3 may precisely understand the service request 5 and thus that he may verify if he is able to execute and manage the request 5.

The detailed information of the service request 5 are also used in the system to implement a scoring system, wherein the interface 4 of the service requestor 2 and/or the interface 6 of the service executors 3 includes means for entering a score to the service requestor 2 and/or to the service executors 3, respectively, which is stored with the data of service requestors 2 and service executors 3 in the database 1. The score of the service executor 3 is set according to a satisfaction of the service requestor 2; for instance, if all the requirements of the service request 5 has been satisfied and thus the quality of the service is considered high, a high score may be given; on the contrary, if not all or no one of the service requirements have been satisfied, a lower score (or a lowest score) is given. Similarly, a score may be given to the service requestor 2 or to the service request 5 by the service executor 5; for example a high score is given when the requests 5 is fully detailed and the service requestor 2 comply with the payment mode and time while a lower score is given when the request 5 is not sufficiently detailed or the service requestor 2 fails to comply with the payment mode and/or time.

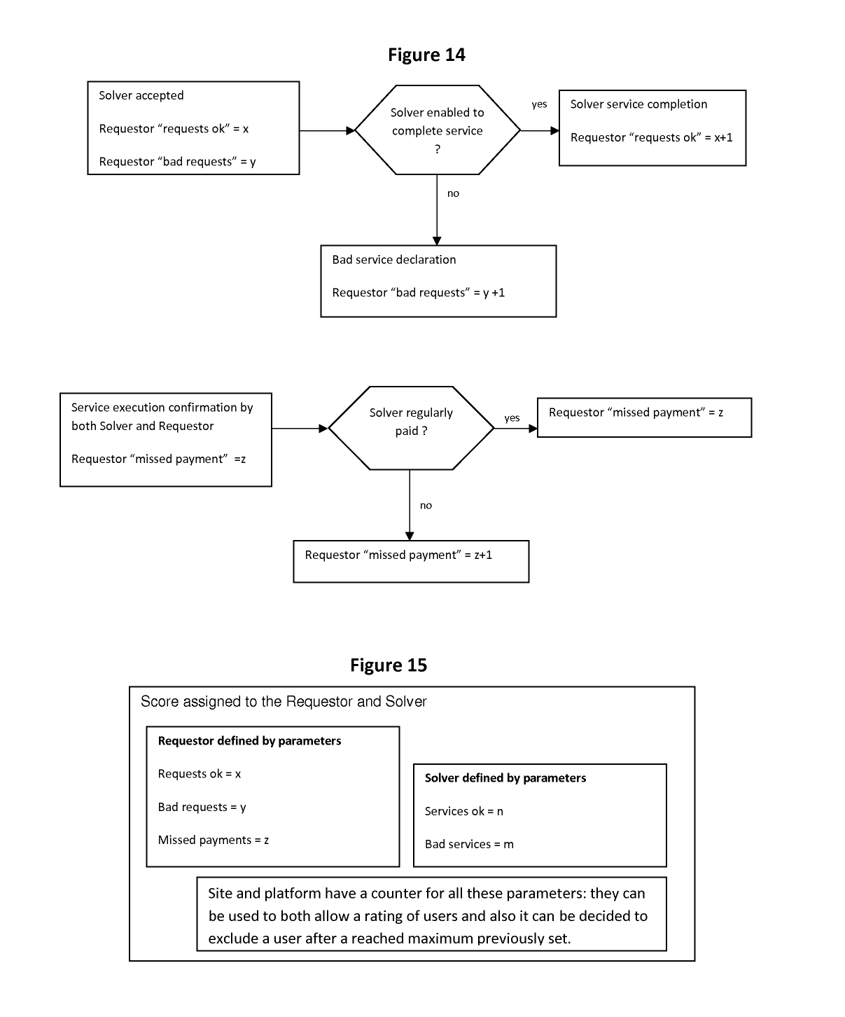

FIGS. 13-15 schematically represents an embodiment of the system supporting the declaration of a bad service provided by the executor (FIG. 13), of a bad request required by the requestor (FIG. 14) and of a missed payment by the part of the requestor after service execution of the executor (FIG. 15). In FIG. 13, in case the service is executed as required (yes arrow), the score of the executor is incremented (n+1) while in case the service is not executed as required (no arrow), the score of the executor is decremented (m+1); in this embodiment, the score is implemented with two separate counters, n, m, n corresponding to the services executed correctly, m corresponding to the services not executed correctly. In the same way, FIG. 14 represents a score system for the service request definition (parameters x, y) and a FIG. 15 a score system (parameters z) for service payments (and thus also for the reliability of a requestor). As shown in FIG. 15, variable m, n, x, y, z are associated to the corresponding users (requestors, executors) of the system.

Again with reference to the information supported by the system, the service request 5 comprises at least one the information in the group of a title of request, a category of the request, a description, a requestor information, a start date of the service request, a start hour of such service, a completion date of the service request, a completion hour of such service, a repetitions frequency, a number of service executors requested for the service execution, a payment information, preferably specifying if the cost of the material is included or not, and/or if the expenses are covered or not, and further a payment mode and a status of the request.

The system also comprises a web interface 6 for the service executors 3, for manually entering data d2 of service executors 3 in the database 1. Such interface is also provided with means for searching service requests 5 and for selecting one or more service requests 5 to be executed. On the other hand, the interface 4 of the service requestors 2 includes means for identifying the service executors 3 who have selected the service requests 5, means for accepting (or refusing) the service execution from a service executor 3 and means for closing the service requests 5 after execution. The means for closing the service request further implement the payment to the service executor 3 for the service executed.

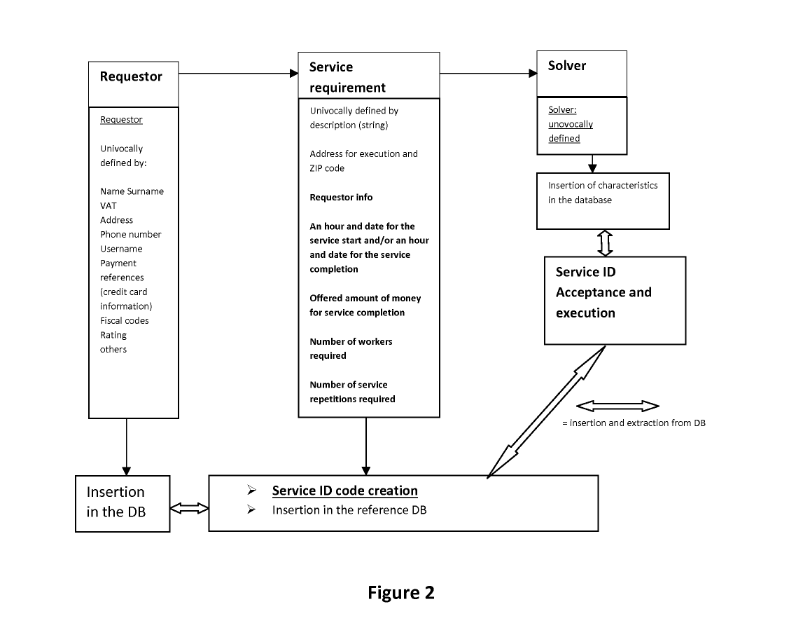

In this respect, FIG. 2 schematically represents the information inserted in the database 1 by the service requestor 2 (requestor), including a service requestor identification, a name and surname, a VAT address, a phone number, a username, payment references, for instance a credit card, fiscal codes, rating, etc. The requestor 2 may enter in the database 1 a service request 5 which is associated to a plurality of information, as explained above, for example the information inside the table “service requirement” of FIG. 2, i.e. a service request identification, for instance a character string univocally identifying the request 5, and address for execution and a ZIP code, a request of information, date and hour required for service execution, amount offered for the service, number of workers required, number of service repetition required, in case the service is requested for more than one time, and in such a case the frequency of repetition, for instance how many time should lapse between a first execution and the following execution of the service. Once the service request 5 has been entered in the system, an identification code or number of the service request 5 is created by the system and saved in the database 1. On the other hand, also the service executor 3 (solver), is univocally identified through a service executor identification.

In order to enter the above indicated information, the interface 4 of the service requestor 2 further include means for entering in the database 1 at least one of the information included in the group of a description of the service request 5, a ZIP code associated to said place, information associated to the service requestor 2, an hour for the service execution and/or an hour for the service completion, and the payment information include at least one of the information included in the group of an offered amount for the service execution, a mode of payment and a time of payment; in the interface 4, means are also provided for entering in the database 1 information on the service requestor 2, including at least one information included in the group of a name and a surname, a VAT number, an address, a phone number, a username payment references, a fiscal codes of the service requestor 2. In the same way, the interface 6 of the service executors 3 includes means for entering at least one of the information included in the group of a name and a surname of the service executors 3, a VAT number, an address, a phone number, a username payment reference, a fiscal code.

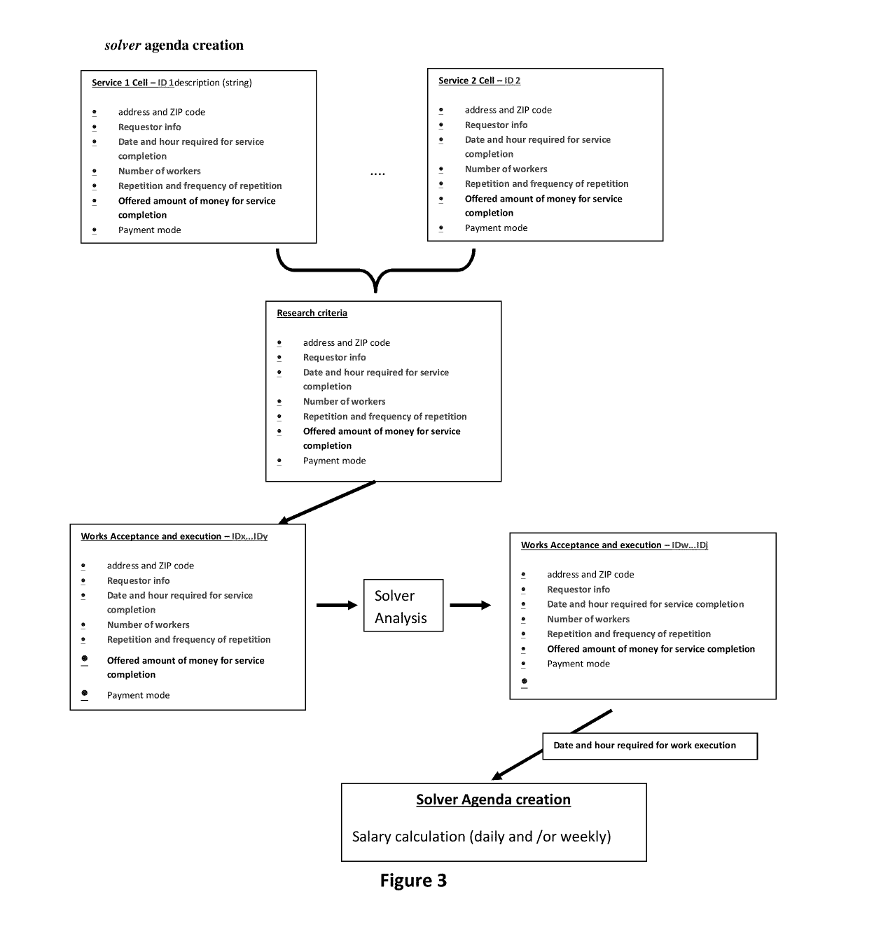

With reference to FIG. 3, steps for creating an agenda for the service executor 3 (solver agenda creation) are schematically represented. In this respect, the interface of the service executors 3 includes an agenda wherein the services selected from an executors 3 for execution and the services accepted by the requestors 2 are displayed, preferably grouped, more preferably grouped by day of the month, and wherein possible overlapping among the selected services and the accepted services are highlighted to prevent conflicts.

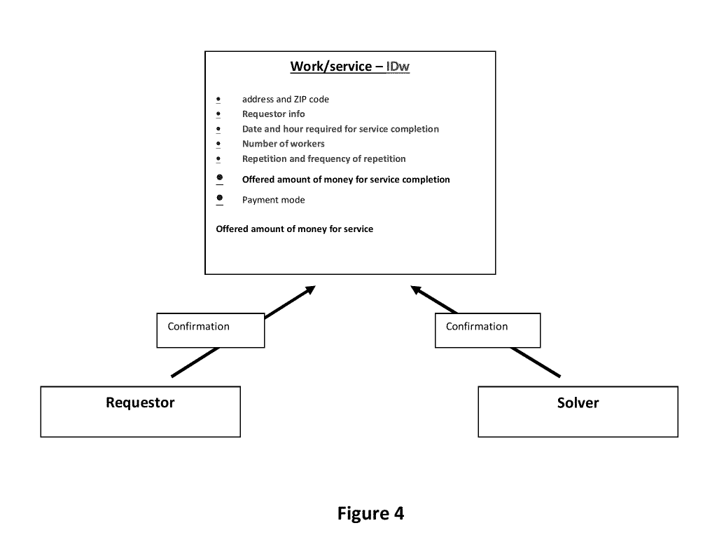

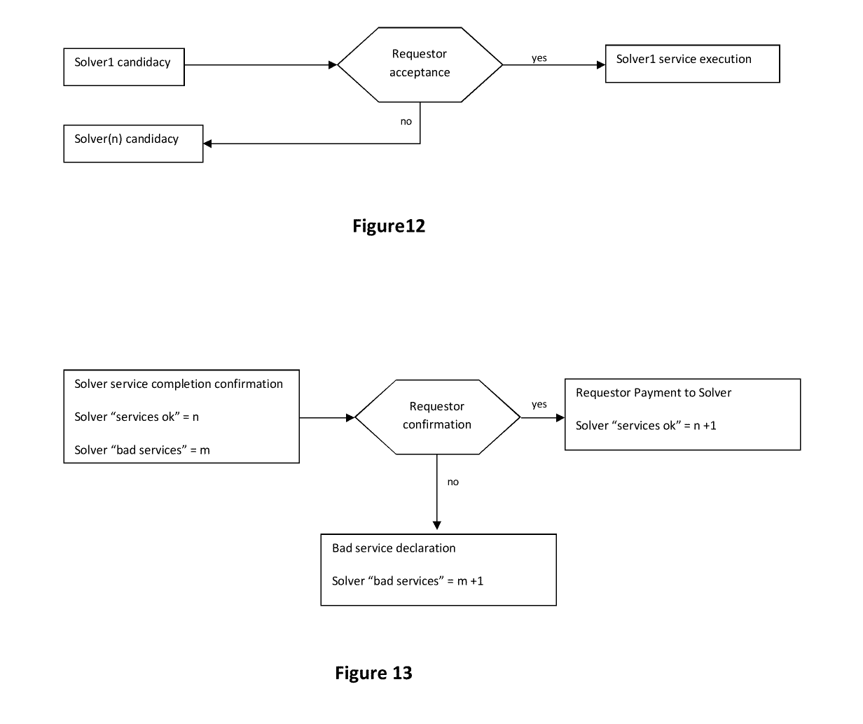

The two blocks in the upper part of FIG. 3 (service cell 1 and 2) represents insertions of service requests 5, the block in the middle of the page (research criteria) represent the way in which a service executor may search the requests, i.e. by address and zip code, by requestor info, etc, and the blocks “work acceptance and execution” represents the process of analysis of the request 5 by the executor 3 and his possible acceptance for execution; more particularly, this process includes also the steps represented in FIG. 4, wherein it is specified that the “work acceptance and execution” involves a double confirmation, one from the side of the service executor 3 who has searched and analyzed the service request 5 and another form the service requestor who has inserted the service request. In this way, a service requestor 2 may refuse a proposal of acceptance of the service request 5 by the part of a service executor 3. As schematically represented in FIG. 12, the refusal may depend on a choice made by the requestor among a plurality of executors candidate to execute the request.

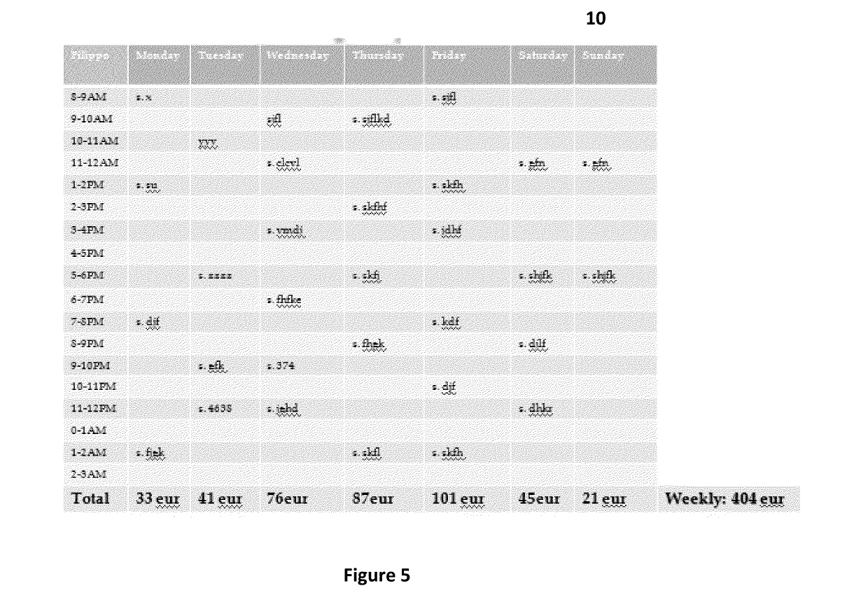

Again with reference to FIG. 3, the block “solver agenda creation” represents the procedure for creating the agenda, which is ultimately represented in FIG. 5, as a table having one column for each day of the week, a plurality of rows corresponding to hours of the day and cells including the requests accepted and scheduled for execution. For each day, the amount gained (or the amount which will be gained) by the service executor 3 for all the service requests 5 of the day is given (for instance 33 EUR for Monday) and a total for the week is also provided (404 EUR), thus giving the executors 3 important information on the expected income. In this respect, means for preventing a selection of a service request 5 in a day and hour including service requests 5 already accepted are provided in the system, thus avoiding overlapping in the scheduling of service requests.

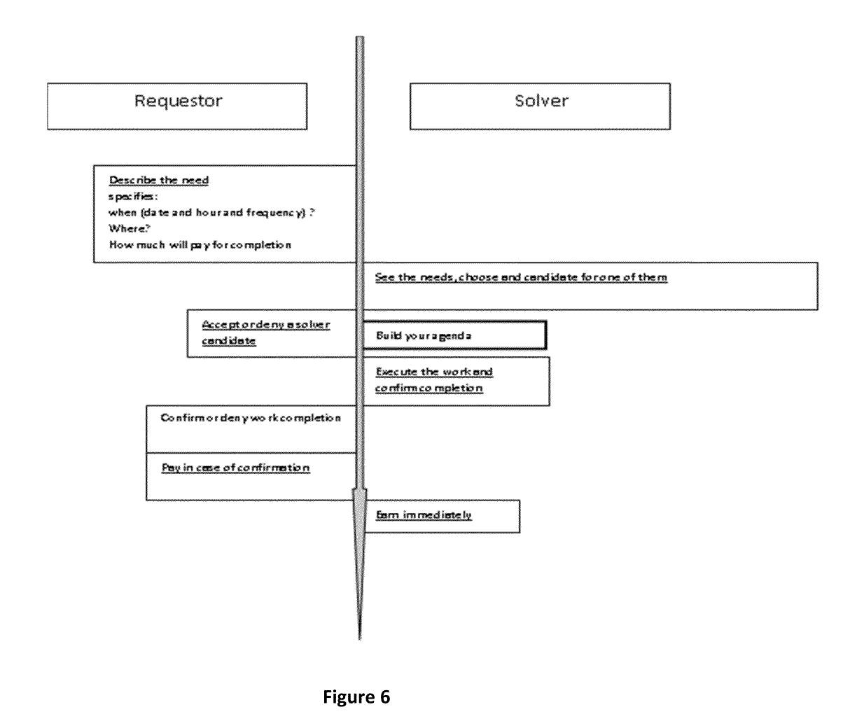

With reference to FIG. 6, a flow diagram schematically represents the flow of the service request 5 which depends on the service requestor 2 and service executor 3 (solver) actions. The requestor 2 inserts the request 5, the executor 3 selects it and candidates for execution, the requestor deny or accept the executor 3 proposal for execution, in the latter case the executor's agenda is updated. Once the job is executed, the executor 3 confirms completion, the requestor 2 also confirm the completion and pay the executor(s) 3 which finally earns.

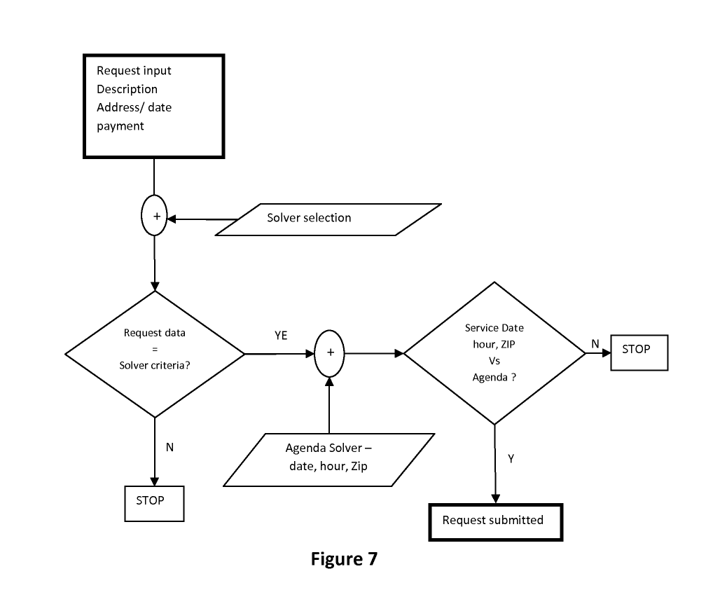

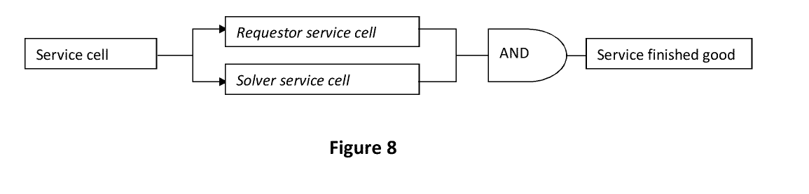

In this respect, the interface 6 of the service executor 4 further comprises means for confirming execution of a service request 5 and which has been already accepted by a service requestor 2 and means for confirming payment receipt for the service execution after payment of the service requestor 2. As represented in FIG. 8, the workload and thus the service execution is terminated only when the requestor 2 and executors 3 both confirm completion of the workflow.

Preferably, portable devices, for instance an i-pad or i-pod, are included in the system for displaying the requestor and executor interfaces. In one embodiment of the invention, the portable device include means for geo-localization, preferably a GPS, and the means for searching the service request 5 cooperate with the geo-localization means to provide the service executors 3 with service requests 5 near an actual location of the service executor 3. According to a preferred embodiment, the service requests 5 associated with an hour in which the service executor 3 is located at a place where in the service request 5 is requested are displayed before. The geo-localization means may further interact with the agenda creation, for example alerting or denying the executors 3 to candidate for execution of a service request 5 which, even if not overlapped in time with another service request 5 already accepted, is in a location too far from such already accepted service request 5 and too proximate in time to be reached in due time for execution. For instance, is the service request A is at place X at 2.00 p.m. and its duration is 1 hour (closed at 3.00 p.m.) and service request B is at place Y at 3.10 p.m., and place A and place B are 100 Kilometers one from the other, the geo-localization means deny that the executor candidate for execution of B. In this respect, the geo-localization means is a module intended to detect an actual position of the executor (i.e. of his portable device) and also intended to process distance between locations X, Y of service requests selected by the executors 3, when the executor is not placed in X or Y.

FIG. 7 schematically represents in more detail the selection of service request 5; more particularly, if the criteria (data) set by the service executor 3 for the search does not correspond to the data of a service request A or if the date, hour or location (ZIP) of a request A selected by the executors corresponds to a date, hour or location (ZIP) of a request B already stored in the agenda of the service executor, the request A is not inserted in the executor's agenda. This feature is optional and can be disabled by any potential executor, allowing to execute small services overlapping them in the same time session.

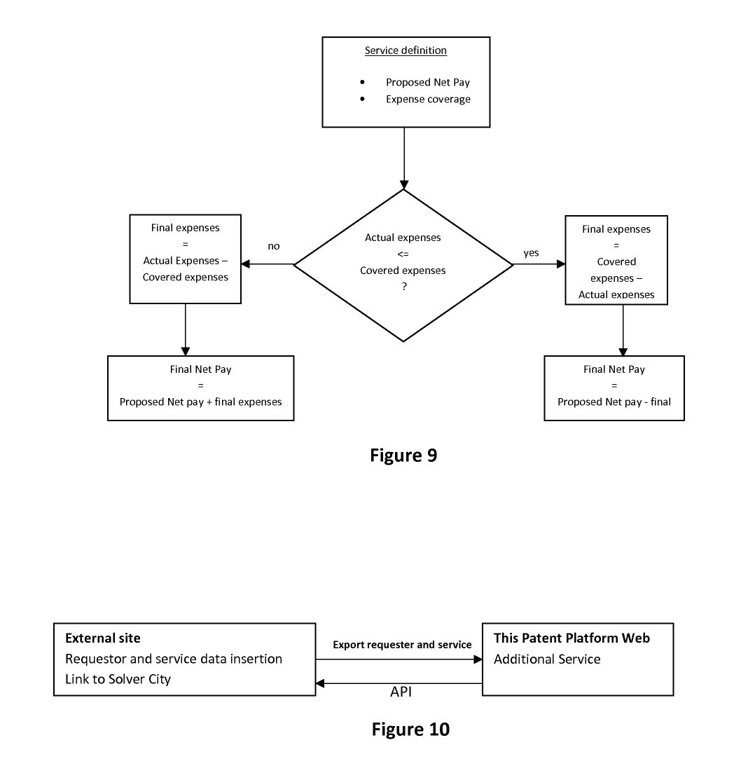

The interface 4 of the service requestor 2 further include means for entering preliminary expenses to be covered by the service requestor 2 with payment before the service execution. Additionally, means for adjusting the payment are provided, when expenses actually billed on the service executors are not covered by an expenses coverage indicated in the service request 5 or vice versa. In such a case, when the coverage is more than the actual expenses, the coverage is decreased to the actual expenses; on the contrary, when the coverage is less than the actual expenses, the coverage is incremented to the actual expenses. A part from the coverage, of course, the net pay proposed in the service request 5 is paid to the executor. FIG. 9 represent an embodiment of the system wherein the adjustment of payment is implemented.

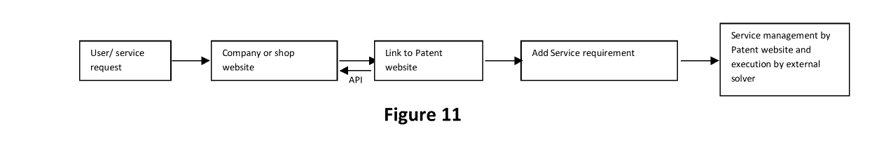

In another aspect of the present invention, the system is integrated with an external site or platform, ad schematically represented in FIG. 10. In other words, an external side (block on the left side) may store information concerning the requestor and the service request and link to an external platform (link to Solvercity) implementing the system (patent platform web) as an additional service. The information concerning the requestor and the service request are exported from the external site to the system which is connected via API. FIG. 11 represent schematically the external site as a company or shop website and the system (patent website) connected via API; from one side, a user may insert service requests into the company or shop site and from the other side the system implement the additional service and support the executors to serve the requests give in input to the system through the company or shop site.

The technical problem at the base of the present invention is also solved by a method implementing the system described above, and more particularly by a method for managing service requests, comprising:
storing in a database 1 data d2, d3 of service requestors 2 and service executors 3;
entering in the database data d2 of service requestors 2;
entering in the database data of the service requests 5, including at least a unique identifier, a date and a place of service request and payment information for the service execution;
entering in the database data d3 of service executors 3;
searching in the database service requests 5 and selecting one or more service requests 5 to be executed,

identifying the executors 3 who have selected the service requests 5, accepting the service execution from a service executor 3 and closing the service requests 5 after execution, wherein closing the service comprises paying the service executor 3 for the executed service.

The advantages of the system and method according to the invention are that a new interoperability between workers (executors) and clients (requestor) may be managed wherein any kind of service (request) may be requested by any requestor and may served by any executor, wherein the request is precisely identified to avoid acceptance by the part of the executor of unexpected efforts and to avoid by the part of the requestor to entrust an executor not able to execute appropriately the service.

The system is also advantageous because unemployed person, also person not having specific technical competence, may search and gain from a plurality of service provided by the system, scheduling his working week and calculating how many money may income from such services, also from services belonging to different categories in which the person is able to operate. In this respect, even if the system and method are mainly intended to help and support unemployed persons and allow them a chance to built their own working, no limitation are given on the skill of the executors, and thus the system and method may be used to support interaction between workers (executors) and clients (requestors), for example, in high tech fields or in field wherein specifically technical competence are required. More particularly, the system may advantageously manage interactions when a) job or single commissions of general purpose are required, when b) shops products or professional workers at home are required, when c) professional council or operations are required at a company.

1. System for managing service requests, comprising:
at least a database (1) for storing data (d2, d3) of service requestors (2) and service executors (3);
a web interface (4) for the service requestors (2), for manually entering data (d2) of service requestors (2) in the database (1) and data of the service requests (5), each service request (5) including at least a unique identifier, a date, a location at which a requested service is to be executed, and payment information for the service execution;
a web interface (6) for the service executors (3), for manually entering data (d2) of service executors (3) in the database (1), for searching service requests (5) and for selecting one or more service requests (5) to be executed,
wherein the interface (4) of the service requestors (2) includes means for identifying the executors (3) who have selected the service requests (5), means for accepting the service execution from a service executor (3) and means for closing the service requests (5) after execution, said means for closing the service request comprising a payment to the service executor (3) for the executed service.

2. System according to claim 1, wherein the interface (4) of the service requestor (2) and/or the interface (6) of the service executors (3) includes means for entering a score to the service requestor (2) and/or to the service executors (3), respectively, said score being stored with the data of service requestors (2) and service executors (3) in said database (1).

3. System according to claim 1, wherein the interface (4) of the service requestor (2) further includes means for entering in said database (1) at least one of the information included in the group of a description of the service request (5), a ZIP code associated to said location, information associated to the service requestor (2), an hour and date for the service start and/or an hour and date for the service completion, and said payment information includes at least one of an offered amount for the service execution, a mode of payment and a time of payment.

4. System according to claim 1, wherein the interface (4) of the service requestor (2) further includes means for entering in the database (1) at least one of the information included in the group of a name and a surname of the service requestor (2), a VAT number, an address, a phone number, a username payment references, a fiscal codes.

5. System according to claim 1, wherein the interface (6) of the service executors (3) further includes at least one of a name and a surname of the service executors (3), a VAT number, an address, a phone number, a username payment reference, a fiscal code.

6. System according to claim 1, wherein the interface of the service executors (3) further includes an agenda (10) wherein the services selected from an executors (3) for execution and the services accepted by the requestors (2) are displayed, preferably grouped, more preferably grouped by day of the month, wherein possible overlapping among said selected services and said accepted services are highlighted to prevent conflicts.

7. System according to claim 1, including means for preventing a selection of a service request in a day and hour including service requests (5) already accepted.

8. System according to claim 1, wherein the interface (6) of the agenda (10) further includes means for calculating and displaying a sum of money for all the service requests (5) executed or to be executed on a certain day of the week or of the month or a sum of money for all the services executed or to be executed in a certain month.

9. System according to claim 1, including a portable device, preferably a smartphone, tablet, mobile phone or computer, for displaying and editing said interfaces (6, 4) and agenda (10).

10. System according to claim 9, wherein said portable device includes means for geo-location, using a Global Positioning System (GPS), wherein said means for searching the service request (5) cooperate with the geo-location means to provide the service executors (3) with service requests (5) near an actual location of the service executor (3).

11. System according to claim 3, wherein said amount for the service execution is set by the service requestor (2) in the service request (5) or is set by the service executor (3), if not set by the service requestor (2) when entering the service request (5).

12. System according to claim 1, wherein the interface (6) of the service executor (4) further comprises means for confirming execution of a service request (5) to be executed and which has been already accepted by a service requestor (2) and means for confirming payment receipt for the service execution after payment of the service requestor (2).

13. System according to claim 3, wherein the interface (4) of the service requestor (2) further includes means for entering in said database (1) at least one of the information included in the group of a number of executors (3) requested to executed a service request (5) and a number and or frequency of repetitions of the service request (5), and a type of payment for said services in the repetition, said type including one payment for each service of said repetition or a unique payment for all the services in the repetition.

14. System according to claim 3, wherein the interface (4) of the service requestor (2) further include means for entering preliminary expenses to be covered by the service requestor (2) with payment before the service execution.

15. System according to claim 1, further supporting phone calls or SMS, or messaging using means for entering in said database (1) data concerning the service request (5), the service requestor (2) or the service executors (3).

16. System according to claim 3, wherein the description of the service request (5) includes a text or audio or video file.

17. System according to claim 1, wherein the service request (5) includes at least one of a title of request, a category of the request, a description, a requestor information, a start date of the service requested, a start time of such service, a completion date of the service requested, a completion time of such service, a repetitions frequency, a number of service executers requested, a payment information, such payment information preferably specifying if the cost of the material is included or not, and/or if the expenses are covered or not, a payment mode, and a status of the request.

18. System according to claim 1, wherein the interface (6) of the service executors (3) and/or the interface (4) of the service requestor (2) further include means for entering in said database a proposal to change the service request (5), said proposal including a change in a time or day for the execution of the service or an amount of the payment.

19. System according to claim 1, wherein, in said agenda (10), the services selected from an executors (3) for execution and the services accepted by the requestors (2) are displayed by their status, wherein said status includes the request being accepted by the requestor and/or executor, the service being running or completed, the request being available, being waiting for confirmation or bad, and wherein said status is set by the requestor or the executor.

20. Method for managing service requests, comprising:
storing in a database (1) data (d2, d3) of service requestors (2) and service executors (3);
entering in the database data (d2) of service requestors (2)
entering in the database data of the service requests (5), including at least a unique identifier, a date and a location at which a requested service is to be executed, and payment information for the service execution;
entering in the database data (d3) of service executors (3),
searching in the database service requests (5) and selecting one or more service requests (5) to be executed,
identifying the executors (3) who have selected the service requests (5),
accepting the service execution from a service executor (3), and
closing the service requests (5) after execution, wherein closing the service comprises paying the service executor (3) for the executed service.

21. Method for managing service requests according to claim 20, including a score or rating process for setting a quality of the service request inserted by a corresponding service requestor and/or a quality of a service provided by an executor, the method including:
entering a score for the service executor according to a satisfaction of requirements of the service request, the score being proportional to a number of satisfied requirements;
entering a score for the service request and the corresponding requestor according to a number of details available in the service request and/or a payment mode and/or a payment time of the service requestor.
